(19) United States
(12) Patent Application Publication
(10) Pub. No.: US 2005/0195706 A1
(43) Pub. Date: Sep. 8, 2005

(54) Optical pickup device for optical disks having different track pitches

(75) Inventor: Won-Jae Hwang, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/912,813

(22) Filed: Aug. 6, 2004

(30) Foreign Application Priority Data
Mar. 8, 2004 (KR) 2004-15482

(51) Int. Cl. G11B 7/00

(52) U.S. Cl. 369/44.23; 369/44.37

(57) ABSTRACT

Disclosed herein is an optical pickup device for optical disks having different track pitches. The optical pickup device performs tracking servo follow-up using the diffraction patterns of the side regions of a beam reflected and diffracted from an optical disk where a tracking error offset attributable to the left or right shift of an object lens is minimized, and performs focus servo follow-up using the diffraction pattern of a center region of the diffracted beam. Accordingly, the present invention performs tracking servo follow-up using the diffraction patterns of the side regions of a light distribution, in which a tracking error offset attributable to the left or right shift of an object lens is minimized, so that the present invention has an effect in that a correct FES/TES for optical disks having different track pitches can be detected.

### BACKGROUND OF THE INVENTION

1. Field of the Invention

The present invention relates generally to an optical pickup device for optical disks having different pitches and, more particularly, to an optical pickup device, which is capable of detecting a tracking error using light intensity distributions detected on both side regions of a beam, which is reflected and diffracted from an optical disk and re-irradiated on an object lens, to minimize a tracking error offset caused by the shift of an optical axis attributable to the shift of the object lens in a radial direction, and performing tracking/focus servo follow-up for optical disks having different track pitches.

2. Description of the Related Art

Recently, due to the large volume of data, there have been developed optical disks, on and from which data is stored and read through a certain optical method, in more detail, a method of storing data by changing the transmittance, reflectance, phase and polarization of light at the location where the data is stored, and deciphering data by reading out the change of the data using light.

That is, an optical disk is a circular-shaped disk on which information is stored, and from which the information is deciphered by irradiating focused laser light thereon and reading out the reflectance of the laser light, or the change of the phase or polarization of the laser light at the time of the laser light being reflected. The optical disk is a storage medium, which creates digital signals in such a way that minute pits whose size is about the wavelength of light are formed on the optical disk, and a digital signal ‘1’ or ‘0’ is created depending on whether a pit exist or not.

Currently, in optical disk markets, Digital Versatile Disk (DVD) multimedia systems, which are compatible with optical disks having different track pitches, in more detail, optical disks, such as a DVD-Random Access Memory (RAM) disk (track pitch: 1.23 μm or 1.48 μm) and a DVD-Read Only Memory (ROM)/±R/±RW (track pitch: 0.74 μm), are being rapidly popularized. Accordingly, in this connection, an optical pickup device is required to have compatibility, which enables the optical pickup device to store certain data on optical disks having different track pitches or read out the data stored on the optical disks.

In this case, to reproduce the data recorded on the optical disk, the optical pickup device functions to focus laser on the optical disk without aberration, focus the quantity of the focused light that is reflected by the diffraction and interference of information pits of the optical disk, and convert the quantity of light into an electric signal.

That is, the optical pickup device performs tracking servo follow-up for the optical disk using a push-pull method or Differential Phase Detection (DPD) method, which uses a single beam to store certain data on the optical disk of a DVD system or read out the data stored in the optical disk, or a Differential Push-Pull (DPP) method, which uses three beams to record data.

With reference to FIGS. 1 to 3, the operation of the optical pickup device performing tracking/focus servo follow-up for optical disks using the push-pull method is described below.

Of the tracking servo follow-up methods for optical disks, the push-pull method, as shown in FIG. 1, uses the difference between the quantities of light detected by a photo detector having a certain configuration, in more detail, a four-segmented configuration, as a Tracking Error Signal (TES). In this case, the TES is represented by the following Equation.
TES=(a+c)−(b+d)

That is, in the case where a light spot, which is formed by a center beam focused on an optical disk through an object lens, as shown in FIG. 2, correctly follows up the signal track of the optical disk, the four-segmented photo diode detects the above-described TES for the optical disk based on the different light distributions P11 of four divided regions, as shown in FIG. 3.

In the case where an optical beam focused by the object lens follows up the center of a signal track, the difference between the light distributions of the photo diode is uniformly represented, and a TES calculated using the Equation (a+c)−(b+d) is zero.

However, in the case where an optical beam focused by the object lens is focused to the right side of the signal track, a large quantity of light is irradiated to the right side of the signal track rather than the left side of the signal track with regard to the difference between the light distributions of the photo diode, so that a TES calculated using Equation (a+c)−(b+d) is represented by a signal having a positive value.

Additionally, in the case where an optical beam focused by the object lens is focused to the left side of the signal track, a large quantity of light is irradiated to the left side of the signal track rather than the right side of the signal track with regard to the difference between the light distributions of the photo diode, so that a TES calculated using the Equation (a+c)−(b+d) is represented by a signal having a negative value.

As described above, in the case where the TES is detected by the photo diode, the optical pickup device drives an actuator based on the detected TES, so that the optical pickup device allows the optical beam focused by the object lens to follow up the center of the signal track, thus performing the tracking servo for the optical disk.

As described above, in the tracking servo follow-up for an optical disk, a light spot focused on the track of the optical disk is required to have a small change in light intensity for a tracking shift attributable to the left or right movement of an object lens.

However, in the case where an optical focus focused by an object lens correctly follows up the center of the signal track but the object lens is offset from the optical axis of a pickup optical system, a large quantity of light is irradiated to one of the left and right sides with regard to the difference between the light distributions of a photo diode, so that a TES calculated using Equation (a+c)−(b+d) has not a zero value but a finite value. Accordingly, a problem arises in that a servo determines that the optical focus is offset from the signal track.

That is, in the case of a DVD-ROM/±R/±RW optical disk whose track pitch is 0.74 μm, a diffracted beam having a diffraction angle, which is larger than an incidence angle that can be accommodated by the object lens, is filtered by the object lens, and only diffracted beams having diffraction orders 0 and ±1, which are not filtered by the object lens, are incident on a hologram and form a base ball-shaped light distribution, as shown in FIG. 5.

Furthermore, in the case of a DVD-RAM optical disk whose track pitch is 1.23 μm or 1.48 μm, the DVD-RAM optical disk has a diffraction angle smaller than that of a DVD-ROM/±R/±RW optical disk due to the track pitch larger than that of the DVD-ROM/±R/±RW optical disk, as shown in FIG. 6. Accordingly, irradiated diffracted beams are filtered less than those for DVD-ROM/±R/±RW optical disk, and are incident on the hologram.

In the case where the object lens shifts to the left or right, the center of the light distribution of an O-order diffracted beam, which is the highest light intensity of light distributions and is formed by being reflected and diffracted by the optical disk, and then, re-focused by the object lens, shifts to the left or right in conjunction with the shift of the object lens, so that an offset signal is added to tracking errors for the optical disk.

That is, in spite of the successive performance of the tracking servo for the optical disk, the center of the light distribution shifts in conjunction with the left or right shift of the object lens. Accordingly, a tracking error offset signal, which indicates that the tracking servo is not successively performed due to a balance of a light intensity distribution, is generated, and thus correct tracking servo follow-up for the optical disk cannot be performed.

To solve the problem, Korean Unexamined Pat. Publication No. 2003-0056090 discloses the technology, which enables light irradiated from an intrinsic laser optical source 11 to form non-diffraction and diffraction light spots through a hologram pattern 13, and overlaps light spots whose light distribution coincide with those of the non-diffraction and diffraction light spots and which are formed by virtual laser optical sources 12a to 12c thereon, thus forming a uniform light intensity distribution on a photo diode 23.

That is, the light irradiated from the intrinsic laser optical source 11 forms non-diffraction light spot 24 on the photo diode 23 by the non-diffraction hologram pattern 14 of the hologram pattern 13.

Furthermore, the light irradiated from the intrinsic laser optical source 11 forms diffraction light spots 25a to 25c on the photo diode 23 by the three diffraction hologram patterns 15a to 15c of the hologram pattern 13.

In this case, the light spots formed by the intrinsic laser form elliptical-shaped light intensity distributions along with the direction of the longitudinal axis of the hologram pattern 13 in which the direction of the longitudinal axis is formed in a field direction.

In this case, the light irradiated from the virtual laser optical sources 12a to 12c has light intensity distributions identical with those of the light spots 24 and 25a to 25c formed by the intrinsic laser optical source 11, and can form a uniform light intensity distribution on the photo diode 23 based on the light intensity distributions of the light spots formed by the intrinsic laser optical source 11, as shown in FIG. 8.

The above-described prior art is advantageous in that a uniform light intensity distribution can be formed on the photo diode 23. However, for this purpose, a plurality of virtual optical sources must be used, so that it is problematic in that the construction thereof is complicated.

Additionally, as another method of performing the tracking servo follow-up, the DPP method is used. However, the DPP method needs accuracy required to locate supplementary beams on the track boundaries. Accordingly, the DPP method is disadvantageous in that the DPP method not only has a difficulty in being simultaneously applied to optical disks having different track pitches but also cannot perform the servo because TESs are considerably reduced when disks having different track pitches are read.

That is, the DPP method cannot be simultaneously applied to a DVD-ROM whose pitch size is 0.74 μm and a 4.7 GB DVD-RAM whose pitch size is 0.615 μm. Accordingly, it is problematic in that a pickup device for multiple-DVDs must be equipped with a system for detecting a TES, which can be applied regardless of the sizes of the different tracks of various DVDs.

### SUMMARY OF THE INVENTION

Accordingly, the present invention has been made keeping in mind the above problems occurring in the prior art, and an object of the present invention is to provide an optical pickup device, which performs tracking/focus servo follow-up for optical disks having different track pitches using the difference between the quantities of light detected on the side regions of a beam diffracted and irradiated from each of the optical disks where a tracking error offset attributable to the left or right shift of an object lens is minimized.

In order to accomplish the above object, the present invention provides a servo follow-up device for optical disks having different track pitches, including an irradiation means for irradiating a single beam focused on optical disks having different pitches, an optical means for focusing the single beam irradiated from the irradiation means on the track of each of the optical disks and transmitting a diffracted beam reflected by the track to an outside, a hologram forming first and second diffraction patterns for tracking servo follow-up by filtering both side regions of a light spot formed by the diffracted beam irradiated through the optical means, and forming a third diffraction pattern for focus servo follow-up by filtering the center region of the light spot, and an optical detection means for detecting a TES for the optical disk using light distributions of the first and second diffraction patterns irradiated from the hologram, and detecting a FES for the optical disk using a light distribution of the third diffraction pattern.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing the construction of a four-segmented photo diode used in an optical pickup device;

FIG. 2 is a view illustrating the principle of a push-pull method of performing the tracking servo follow-up of the optical pickup device;

FIG. 3 is a view showing the light intensity distribution according to the configuration of a light spot focused on the photo diode using the push pull method of the optical pickup device;

FIG. 4 is a graph showing the light distribution of a laser beam used in the optical pickup device;

FIG. 5 is a view showing the configuration of a light distribution formed by a diffracted beam irradiated from an optical disk (DVD±R/RW);

FIG. 6 is a view showing the configuration of a light distribution formed by a diffracted beam irradiated from an optical disk (DVD-RAM);

FIG. 7 is a view showing the construction of a conventional optical pickup device for maintaining a uniform light distribution focused on the photo diode;

FIG. 8 is a view showing a light intensity distribution formed on the photo diode by the conventional optical pickup device of FIG. 7;

FIG. 9 is a view showing the construction of an optical pickup device according to an embodiment of the present invention;

FIG. 10 is a view showing the construction of the optical pickup device according to another embodiment of the present invention;

FIG. 11 is a view showing the hologram patterns of a hologram according to the present invention; and

FIG. 12 is a view showing the optical detection patterns of an optical detection means according to the present invention.

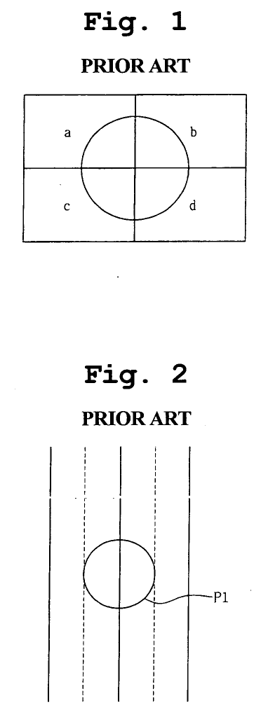

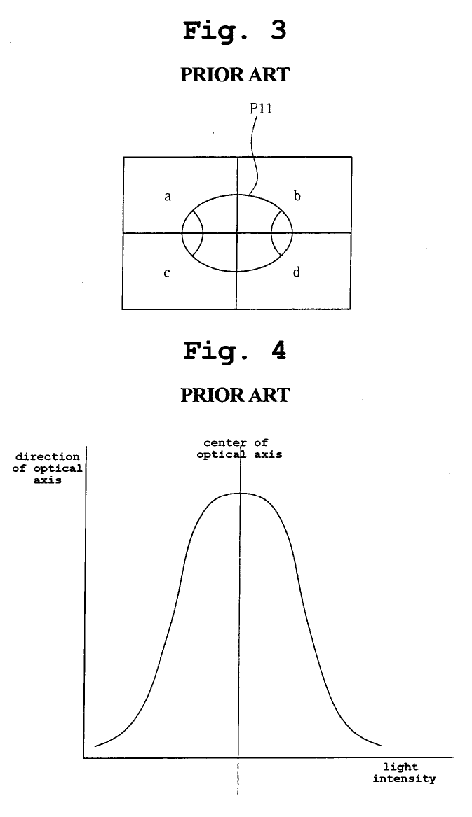

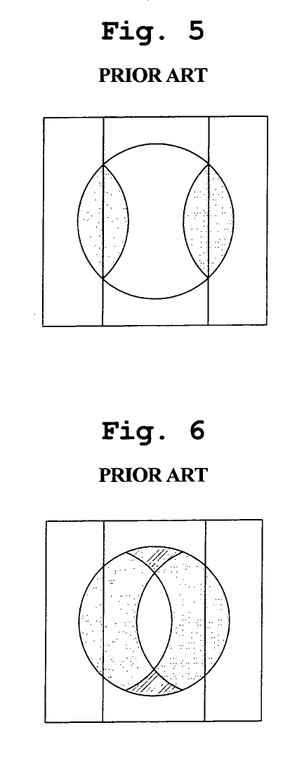

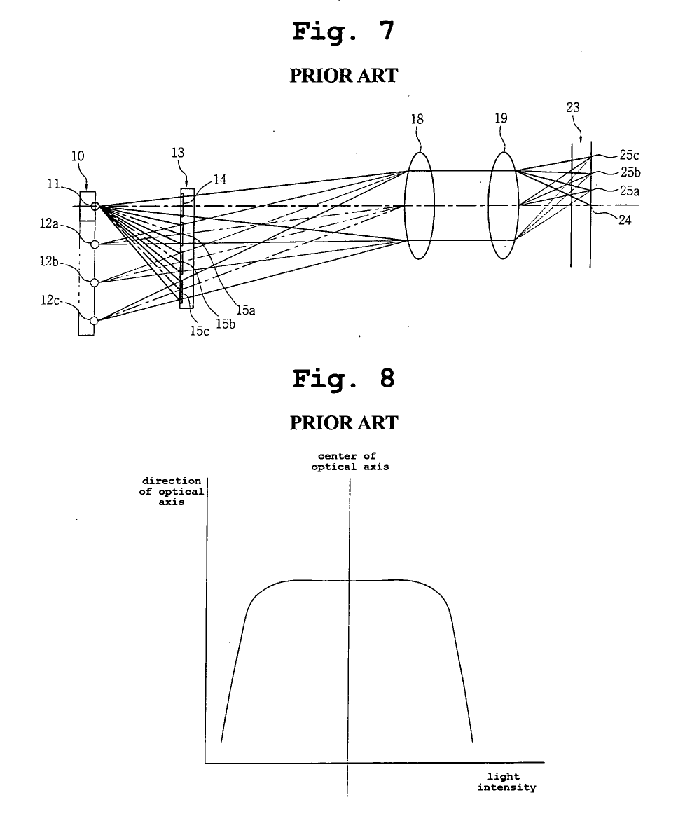

### DESCRIPTION OF THE PREFERRED EMBODIMENTS

Hereinafter, an optical pickup device for optical disks having different track pitches according to the present invention is described in detail with reference with the attached drawings.

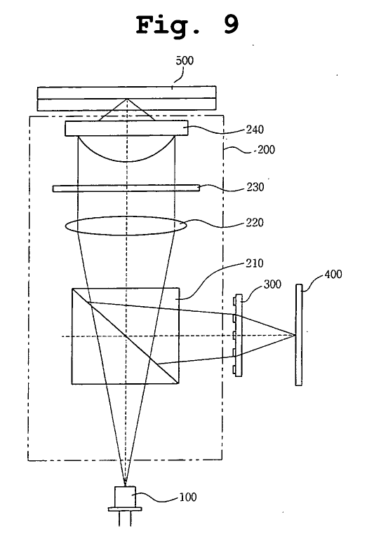

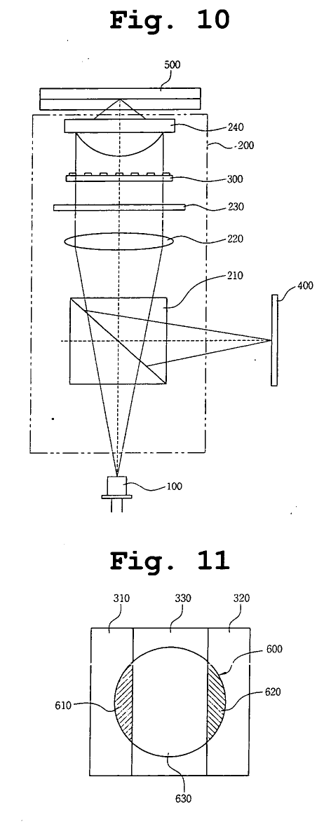

The construction of a servo follow-up device for optical disks according to the present invention is described with reference to FIGS. 9 and 10.

The optical pickup device for optical disks having different track pitches detects a tracking error by detecting the difference between the quantities of light detected on the side regions of a beam, which is reflected and diffracted from each of optical disks and re-irradiated on an object lens, to minimize a tracking error offset caused by the shift of an optical axis, that is, the shift of the center of a light distribution attributable to the shift of the object lens in a radial direction, and performs tracking/focus servo follow-up for the optical disks having different track pitches. As shown in FIG. 9, the optical pickup device includes a radiation means 100, an optical means 200, a hologram 300 and an optical detection means 400.

In this case, the radiation means 100 is a means for recording or reproducing audible and/or visual data on or from an optical disk 500 in which tracks having a certain shape are formed, or radiating laser light to detect a focus/tracking signal so as to correctly read data recorded on the tracks. In practice, the radiation means 100 is a laser diode.

The optical means 200 is a means for functioning to focus the laser light radiated from the radiation means 100 on the tracks of the optical disk 500. As shown in FIG. 9, the optical means 200 includes a beam splitter 210, a collimator lens 220, a wave plate 230 and an object lens 240.

The beam splitter 210 functions to diverge the laser light irradiated from the radiation means 100 to the direction in which the optical disk 500 is located.

Additionally, the beam splitter 210 receives the laser light reflected by the optical disk 500, and functions to diverge the laser light to the directions in which the hologram means 300 and the optical detection means 400, which will be described later, are located.

The collimator lens 220 converts linearly polarized light, which has been diverged by the beam splitter 210 and irradiated on the collimator lens 220, into parallel light, and irradiates the parallel light on the wave plate 230.

The wave plate 230 converts the linearly polarized laser light irradiated parallel on the collimator lens 220 into circularly polarized laser light, and then functions to irradiate the converted laser light to the object lens 240.

The object lens 240 functions to focus the laser light irradiated from the wave plate 230 on the optical disk 500 storing certain audible and/or visual data, in more detail, a DVD-RAM disk whose track pitch is 1.23 μm or 1.48 μm, or a DVD-ROM/+R/+RW disk whose track pitch is 0.74 μm.

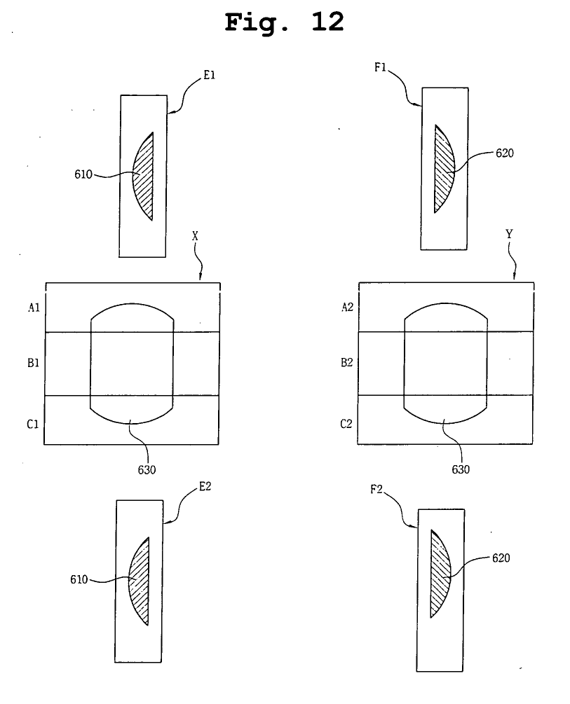

The hologram 300 is located in front of the optical detection means 400 detecting the TES/FES for the optical disk 500, and functions to filter a certain region of a light spot 600 formed by the diffracted beam reflected by the optical disk 500. As shown in FIG. 11, the hologram has a three-divided construction including a first hologram pattern 310, a second hologram pattern 320 and a third hologram pattern 330.

Additionally, the hologram 300, as shown in FIG. 10, is located to allow the optical axis thereof to coincide with that of the object lens 240 forming the optical means 200, and may function to filter a certain region of the diffracted beam reflected from the optical disk 500 in conjunction with the object lens 240.

In this case, the first hologram pattern 310 filters the one side region of the light spot 600 formed by the diffracted beam, and forms a first diffraction pattern 610 having a certain shape used at the time of detecting a TES.

Then, the first hologram pattern 310, as shown in FIG. 12, functions to focus the first diffraction pattern 610 on first and second optical detection patterns E1 and E2 by diffracting the first diffraction pattern 610 toward the first and second optical detection patterns E1 and E2 formed on the optical detection means 400 that detects a TES.

The second hologram pattern 320 filters the other side region of the light spot 600 formed by the diffracted beam, and forms a second diffraction pattern 620 having a certain shape used at the time of detecting a TES.

Then, the second hologram pattern 320, as shown in FIG. 12, functions to focus the second diffraction pattern 620 on fourth and fifth optical detection patterns F1 and F2 by diffracting the second diffraction pattern 620 toward the fourth and fifth optical detection patterns F1 and F2 for the detection of a tracking error, which are formed on the optical means 400.

That is, the first and second hologram patterns 310 and 320 focus the first and second diffraction patterns 610 and 620, which are formed by the side regions having a light intensity distribution less influenced by a tracking offset error attributable to the left or right shift of the object lens 240, on the optical detection means 400, so that the tracking error offset is minimized, and thus the optical detection means 400 can perform the correct tracking servo follow-up for the optical disks having different track pitches.

The third hologram pattern 330 filters the center region of the light spot 600 formed by the diffracted beam, and forms the third diffraction pattern 630 having a certain shape used at the time of detecting an FES.

Then, the third hologram pattern 330 functions to focus the third diffraction pattern 630 on a third optical detection and a sixth optical detection pattern Y pattern X by diffracting the third diffraction pattern 630 toward the third optical detection pattern X patterned to three-divided regions A1, B1, and C1 formed on the optical means 400, and toward the sixth optical detection pattern Y patterned to another three-divided regions A2, B2, and C2 formed on the optical means 400.

That is, the third hologram pattern 330 focuses the third diffraction pattern 630, which is formed by the center region of the light spot 600 reflected and irradiated by the optical disk 500, on the third and sixth optical detection patterns X and Y for the detection of an FES, which are formed on the optical detection means 400 using characteristics in which focal distances are different due to a diffraction coefficient, so that the optical detection means 400 can perform the correct focus servo follow-up for the optical disks 500 having different track pitches.

The optical detection means 400 is a means for calculating the light distribution of the light spot 600 incident through the hologram 300, and detecting a TES/FES for the optical disk. In the optical detection means 400, the first and second optical detection patterns E1 and E2 for the detection of a TES and the third optical detection pattern X for the detection of an FES are formed on one side of the optical detection means 400, as shown in FIG. 12. In contrast, the fourth and fifth optical detection patterns F1 and F2 for the detection of a TES and the sixth optical detection pattern Y for the detection of an FES are formed on the other side thereof to be symmetrical to the first and second optical detection patterns E1 and E2 and the third optical detection pattern X.

That is, on one side of the optical detection means 400 is formed the first optical detection pattern E1, on which the first diffraction pattern 610 filtered by the first hologram pattern 310 of the hologram 300 and formed by the one side region of the light spot that is less influenced by a tracking error offset attributable to the left or right shift of the object lens is focused.

Additionally, on one side of the optical detection means 400 is formed the second optical detection pattern E2, on which the first diffraction pattern 610 filtered by the first hologram pattern 310 of the hologram 300 and formed by the one side region of the light spot that is less influenced by a tracking error offset attributable to the left or right shift of the object lens is focused, to be spaced apart from the first optical detection pattern E1.

On the other side of the optical detection means 400 is formed the fourth optical detection pattern F1, on which the second diffraction pattern 620 filtered by the second hologram pattern 320 of the hologram 300 and formed by the other side of the light spot 600 that is less influenced by a tracking error offset attributable to the left or right shift of the object lens 240 is focused, to be symmetrical to the first optical detection pattern E1.

Additionally, on the other side of the optical detection means 400 is formed the fifth optical detection pattern F1, on which the second diffraction pattern 620 filtered by the second hologram pattern 320 of the hologram 300 and formed by the other side of the light spot 600 that is less influenced by a tracking error offset attributable to the left or right shift of the object lens 240 is focused, to be symmetrical to the second optical detection pattern E2.

The optical detection means 400 constructed as described above detects a TES for the optical disk using the light distributions of the first and second diffraction patterns 610 and 620, which are focused on the first and second optical detection patterns E1 and E2 and the fourth and fifth optical detection patterns F1 and F2, respectively, as the variables of the following Equation.
TES=(E1+E2)−(F1+F2) (1)

That is, the optical detection means 400 uses the light distributions of the first and second diffraction patterns 610 and 620, which are formed by the both side regions of the light spot 600 less influenced by the left or right shift of the object lens, as the variables of Equation 1, thus detecting the TES in which a tracking error offset for the optical disks 500 having different track pitches is minimized.

On one side of the optical detection means 400 is formed the third optical detection pattern X, on which the third diffraction pattern 630 formed by the light distribution of the center region of the light spot 600 that is diffracted by the third hologram pattern of the hologram 300 is focused, between the first and second optical patterns E1 and E2.

In this case, the third optical detection pattern X is divided into three regions A1, B1 and C1, in which the third diffraction pattern 630 is focused while being divided into uniform light distributions.

Additionally, on the other side of the optical detection means 400 is formed the sixth optical detection pattern Y, on which the third diffraction pattern 630 formed by the light distribution of the center region of the light spot 600 diffracted by the third hologram pattern of the hologram 300 is focused, is formed between the fourth and fifth optical detection means F1 and F2 to be symmetrical to the third optical detection pattern X.

In this case, the sixth optical detection pattern Y is divided into three regions A2, B2 and C2, in which the third diffraction pattern is focused to be divided into uniform light distributions.

The optical detection means 400 constructed as described above uses the light distribution of the third diffraction pattern 630, which is divided and focused on the three-divided regions A1, B1 and C1 of the third optical detection pattern X and the three-divided regions A2, B2 and C2 of the sixth optical detection pattern Y, as the variables of the following Equation, thus detecting the FES for the optical disk.
FES=(A1+B2+C1)−(A2+B1+C2) (2)

That is, the optical detection means 400 uses the light distribution of the third diffraction pattern 630, which has another focal distance according to a certain diffraction coefficient and formed by the light distribution of the center region of diffracted beams diffracted by the third hologram pattern 630 of the hologram 300, as the variables of Equation 2, thus detecting an FES for the optical disk 500.

As described above, the present invention performs tracking servo follow-up using the difference between the quantities of light on both side regions of a diffracted beam of the light distribution of the diffracted beam reflected by an optical disk to minimize a tracking error offset attributable to the left or right shift of an object lens, so that the present invention has an effect in that a correct FES/TES for optical disks having different track pitches can be detected.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A servo follow-up device for optical disks having different track pitches, comprising:
irradiation means for irradiating a single beam focused on optical disks having different pitches;
optical means for focusing the single beam irradiated from the irradiation means on a track of each of the optical disks and transmitting a diffracted beam reflected by the track to an outside;
a hologram forming first and second diffraction patterns for tracking servo follow-up by filtering both side regions of a light spot formed by the diffracted beam irradiated through the optical means, and forming a second diffraction pattern for focus servo follow-up by filtering a center region of the light spot; and
optical detection means for detecting a Tracking Error Signal (TES) for the optical disk using light distributions of the first and second diffraction patterns irradiated from the hologram, and detecting a Focus Error Signal (FES) for the optical disk using a light distribution of the third diffraction pattern.

2. The servo follow-up device as set forth in claim 1, wherein the radiation means is a short wavelength laser diode.

3. The servo follow-up device as set forth in claim 1, wherein the optical means comprises:
a beam splitter diverging linearly polarized beam irradiated from the radiation means to a direction in which the optical disk is located, and diverging linearly polarized diffracted beam that is formed by being reflected and diffracted by the optical disk to a direction in which the hologram is located;
a collimator lens converting the linearly polarized diffracted beam diverged and irradiated from the beam splitter into a parallel beam;
a wave plate converting the linearly polarized diffracted beam incident through the collimator lens into a circularly polarized diffracted beam, converting the circularly polarized diffracted beam diffracted and irradiated by the optical disk into a linearly polarized diffracted beam, and irradiating the converted diffracted beam on the collimator lens; and
an object lens focusing the circularly polarized diffracted beam irradiated from the wave plate, and thus forming a light spot of a certain shape on the track of the optical disk.

4. The servo follow-up device as set forth in claim 1, wherein the hologram comprises:
a first hologram pattern forming a first diffraction pattern by filtering a first side region of a diffracted beam having a light intensity distribution, in which a tracking error offset attributable to a left or right shift of the object lens is minimum;
a second hologram pattern forming a second diffraction pattern by filtering a second side region of the diffracted beam having the light intensity distribution, in which the tracking error offset attributable to the left or right shift of the object lens is minimum; and
a third hologram pattern forming a third diffraction pattern by filtering a center region of the diffracted beam.

5. The servo follow-up device as set forth in claim 4, wherein the first to third hologram patterns each have a rectangular structure in which a longitudinal axis thereof is formed in a direction perpendicular to an irradiation direction of the diffracted beam.

6. The servo follow-up device as set forth in claim 1, wherein the optical detection means is formed in such a way that:
first and second optical detection patterns E1 and E2, on which a first diffraction pattern formed by a first side region of the light spot is focused, and a third optical detection pattern, on which a third diffraction pattern formed by the center region of the light spot between the first and second optical detection patterns E1 and E2 is focused, are formed on a first side of the optical detection means; and
fourth and fifth optical detection patterns F1 and F2, on which a second diffraction pattern formed by a second side region of the light spot is focused, and a sixth optical pattern, on which the third diffraction pattern formed by the center region of the light spot between the fourth and fifth optical detection patterns F1 and F2 is focused, are formed on a second side of the optical detection means to be symmetrical to the first and second optical detection patterns E1 and E2 and the third optical detection pattern.

7. The servo follow-up device as set forth in claim 6, wherein the optical detection means is a photo diode.

8. The servo follow-up device as set forth in claim 6, wherein the first and second optical detection patterns E1 and E2 and the fourth and fifth optical detection patterns F1 and F2 of the optical detection means each form a rectangular structure in which a longitudinal axis thereof lies in a direction perpendicular to irradiation directions of the first and second diffraction patterns.

9. The servo follow-up device as set forth in claim 8, wherein the optical detection means is a photo diode.

10. The servo follow-up device as set forth in claim 7, wherein the optical detection means detects a TES for the optical disks having different track pitches using the following Equation:
TES=(E1+F2)−(F1+F2)
in the case where the first diffraction pattern is focused on the first and second optical detection patterns E1 and E2, and the second diffraction pattern is focused on the fourth and fifth optical detection patterns F1 and F2.

11. The servo follow-up device as set forth in claim 10, wherein the optical detection means is a photo diode.

12. The servo follow-up device as set forth in claim 6, wherein the third optical detection pattern of the optical detection means is divided into a first region A1, a second region B1 and a third region C1, and the sixth optical detection pattern of the optical detection means is divided into a first region A2, a second region B2 and a third region C2; and
the third and sixth optical detection patterns each form a rectangular structure in which a longitudinal axis lies in a direction perpendicular to an irradiation direction of the third diffraction pattern.

13. The servo follow-up device as set forth in claim 12, wherein the optical detection means is a photo diode.

14. The servo follow-up device as set forth in claim 8, wherein the optical detection means detects an FES for the optical disks having different track pitches using the following Equation:
FES=(A1+B2+C1)−(A2+B1+C2)
in the case where the third diffraction pattern is focused on the three-divided regions A1, B1 and C1 of the third optical detection pattern and the three-divided regions A2, B2 and C2 of the sixth optical detection pattern.

15. The servo follow-up device as set forth in claim 14, wherein the optical detection means is a photo diode.

16. The servo follow-up device as set forth in claim 6, wherein the optical detection means detects a TES for the optical disks having different track pitches using the following Equation:
TES=(E1+F2)−(F1+F2)
in the case where the first diffraction pattern is focused on the first and second optical detection patterns E1 and E2, and the second diffraction pattern is focused on the fourth and fifth optical detection patterns F1 and F2.

17. The servo follow-up device as set forth in claim 16, wherein the optical detection means is a photo diode.
